(19) United States
(12) Patent Application Publication
(10) Pub. No.: US 2020/0313198 A1
(43) Pub. Date: Oct. 1, 2020

(54) COMPOSITE CURRENT COLLECTOR AND COMPOSITE ELECTRODE AND ELECTROCHEMICAL DEVICE INCLUDING THE SAME

(71) Applicant: NINGDE AMPEREX TECHNOLOGY LIMITED, Ningde City (CN)

(72) Inventors: Yibo ZHANG, Ningde City (CN); Bin WANG, Ningde City (CN); Xiang LI, Ningde City (CN); Qiaoshu HU, Ningde City (CN)

(21) Appl. No.: 16/798,996

(22) Filed: Feb. 24, 2020

(30) Foreign Application Priority Data
Mar. 29, 2019 (CN) 201910250322.4

(51) Int. Cl. H01M 4/66; H01M 4/134; H01M 4/52; H01M 4/36; H01M 10/0525; H01M 10/0565

(52) U.S. Cl. CPC H01M 4/667; H01M 4/661; H01M 4/134; H01M 10/0565; H01M 4/366; H01M 10/0525; H01M 4/52

(57) ABSTRACT

A composite current collector includes: an intermediate layer, having a first surface and a second surface opposite to the first surface, and the intermediate layer being an electronically insulated ionic conductor; a first metal layer, disposed on the first surface; and a second metal layer, disposed on the second surface, wherein the first metal layer and the second metal layer separately include at least one hole, the hole exposing a part of the first surface and a part of the second surface. Since the intermediate layer is an ionic conductor, the part exposed from the hole can effectively form ion path connecting active materials on both sides of the composite current collector, thereby improving ion conductivity. In addition, the composite electrode helps to ensure the capacity performance of the cathode and anode active materials, thereby further improving the energy density of the composite electrode.

### CROSS REFERENCE TO RELATED APPLICATIONS

The present application claims the benefit of priority from the China Patent Application No. 201910250322.4, filed on 29 Mar. 2019, the disclosure of which is hereby incorporated by reference in its entirety.

### BACKGROUND

### 1. Technical Field

The present application relates to the field of energy storage technologies, and more particularly to a composite current collector, a composite electrode including the same, and an electrochemical device.

### 2. Description of the Related Art

Lithium-ion batteries have many advantages, such as large volume and mass energy density, long cycle life, high nominal voltage, low self-discharge rate, small size, light weight, etc., and are widely applied in the field of consumer electronics. With the rapid development of electric vehicles and mobile electronic devices in recent years, there is a growing demand for higher energy density, safety, and cycle performance of lithium-ion batteries.

A current collector is an important component in a lithium-ion battery, and has the function of collecting current generated by the active materials of the lithium-ion battery to form a relatively large current for external output. The use of a composite current collector can further increase energy density, and improve durability and elongation so as achieving process optimization in production, increase unit mass energy density, and improve safety.

In order to further improve the electrical performance of an electrochemical device, it is necessary to further optimize the composite current collector.

### SUMMARY

The present application provides a composite current collector, a composite electrode including the same, and an electrochemical device in an attempt to solve at least one of the problems found in the related art to a certain extent.

According to a first aspect of the present application, the present application provides a composite current collector, including: an intermediate layer, having a first surface and a second surface opposite to the first surface, and the intermediate layer being an electronically insulated ionic conductor; a first metal layer, disposed on the first surface; and a second metal layer, disposed on the second surface. The first metal layer and the second metal layer each include at least one hole, the hole exposing a part of the first surface and a part of the second surface. Since the intermediate layer has ion conductivity, both sides of the composite current collector can be connected by the hole to form an ion path, thereby improving the ion conductivity of the composite current collector, and improving the electrical performance.

According to some embodiments of the present application, the average pore size of the hole is about 20 μm to about 3,000 μm, the average pore density is about 1 pore/cm² to about 100 pores/cm², and the average pore area ratio is about 0.001% to about 30%.

According to some embodiments of the present application, the first metal layer and the second metal layer are each at least one independently selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and a combination thereof.

According to some embodiments of the present application, the ionic conductor is at least one selected from the group consisting of polyvinylidene fluoride-hexafluoropropylene (PVDF-HFP), polyvinylidene fluoride (PVDF), polyacrylonitrile (PAN), polymethyl methacrylate (PMMA), polyphenyl ether (PPO), polypropylene carbonate (PPC), polyethylene oxide (PEO), and derivatives thereof.

According to a second aspect of the present application, the present application provides a composite electrode, including: the composite current collector in the above embodiments; a cathode active material layer, disposed on the first metal layer; and an anode active material layer, disposed on the second metal layer.

According to some embodiments of the present application, the cathode active material layer may cover a part of the exposed part or the entire exposed part of the first surface, and the anode active material layer may cover a part of the exposed part or the entire exposed part of the second surface.

According to some embodiments of the present application, the composite electrode further includes a conductive coating layer, disposed in at least one of the following two situations: between the cathode active material layer and the first metal layer, or between the anode active material layer and the second metal layer.

According to some embodiments of the present application, the conductive coating layer includes a conductive agent and a polymer, the conductive agent being at least one selected from the group consisting of carbon nanotubes, conductive carbon black, acetylene black, artificial graphite, graphene, and metal nanowires.

According to some embodiments of the present application, the polymer is at least one selected from the group consisting of polyethylene terephthalate, polybutylene terephthalate, polyethylene naphthalate, polyetheretherketone, polyimide, polyamide, polyethylene glycol, polyamideimide, polycarbonate, cyclic polyolefin, polyphenylene sulfide, polyvinyl acetate, polytetrafluoroethylene, polymethylene naphthalene, polyvinylidene difluoride, polyethylene naphthalate, polypropylene carbonate, poly(vinylidene fluoride-hexafluoropropylene), poly(vinylidene fluoride-co-chlorotrifluoroethylene), silicone, vinylon, polypropylene, polyethylene, polyvinyl chloride, polystyrene, polyether nitrile, polyurethane, polyphenylene ether, polyester, polysulfone, and derivatives thereof.

According to a third aspect of the present application, the present application provides an electrode assembly, including the composite electrode in the above embodiments.

According to a fourth aspect of the present application, the present application provides an electrochemical device, including the electrode assembly in the above embodiments.

According to some embodiments of the present application, the electrochemical device is a lithium-ion battery.

According to a fifth aspect of the present application, the present application further provides an electronic device, including the electrochemical device in the above embodiments.

Additional aspects and advantages of the embodiments of the present application will be described or shown in the following description or interpreted by implementing the embodiments of the present application.

### BRIEF DESCRIPTION OF THE DRAWINGS

The following will briefly illustrate the accompanying drawings necessary to describe the embodiments of the present application or the existing technology so as to facilitate the description of the embodiments of the present application. Obviously, the accompanying drawings described below are only part of the embodiments of the present application. For a person skilled in the art, the accompanying drawings of other embodiments can still be obtained according to the structures illustrated in the accompanying drawings without any creative effort.

FIG. 1A is a cross-sectional view of a structure example of a composite current collector in some embodiments of the present application.

FIG. 1B is a top view of a structure example of a composite current collector in some embodiments of the present application.

FIG. 2 is a cross-sectional view of a structure example of a composite electrode according to some embodiments of the present application.

### EMBODIMENTS

Embodiments of the present application are described in detail below. Throughout the specification, the same or similar components and components having the same or similar functions are denoted by similar reference numerals. The embodiments described herein with respect to the accompanying drawings are illustrative and graphical, and are used for providing a basic understanding of the present application. The embodiments of the present application should not be construed as limiting the present application.

As used herein, the terms “substantially”, “generally”, “essentially” and “about” are used to describe and explain small variations. When being used in combination with an event or circumstance, the term may refer to an example in which the event or circumstance occurs precisely, and an example in which the event or circumstance occurs approximately. For example, when being used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if the difference value between the two values is less than or equal to ±10% of the average of the values (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), then the two values can be considered “substantially” the same.

In the specification, unless otherwise particularly specified or defined, relative terms such as “center”, “longitudinal”, “lateral”, “front”, “rear”, “right”, “left”, “internal”, “external”, “lower”, “higher”, “horizontal”, “vertical”, “higher than”, “lower than”, “upper”, “lower”, “top”, “bottom” and their derivatives (such as “horizontally”, “downward”, and “upward”) should be construed as referring to the directions described in the specification or shown in the accompanying drawings. These relative terms are used for convenience only in the description and are not required to construct or operate the present application in a particular direction.

In addition, amounts, ratios and other numerical values are sometimes presented herein in a range format. It should be appreciated that such range formats are for convenience and conciseness, and should be flexibly understood as including not only values explicitly specified to range constraints, but also all individual values or sub-ranges within the ranges, like explicitly specifying each value and each sub-range.

In the detailed description and the claims, a list of items connected by the term “at least one of” or similar terms may mean any combination of the listed items. For example, if items A and B are listed, then the phrase “at least one of A and B” means only A; only B; or A and B. In another example, if items A, B and C are listed, then the phrase “at least one of A, B and C” means only A; or only B; only C; A and B (excluding C); A and C (excluding B); B and C (excluding A); or all of A, B and C. The item A may include a single component or multiple components. The item B may include a single component or multiple components. The item C may include a single component or multiple components.

The present application further improves the design of a composite current collector. The improved composite current collector includes an intermediate layer, a first metal layer, and a second metal layer. The intermediate layer has a first surface and a second surface opposite to the first surface, and the intermediate layer is an electrically insulated ionic conductor. The first metal layer is disposed on the first surface. The second metal layer is disposed on the second surface. The first metal layer and the second metal layer separately includes at least one hole, and the hole exposes a part of the first surface from the first metal layer and exposes a part of the second surface from the second metal layer. Since the intermediate layer has ion conductivity, the ion conductivity of the composite current collector can be improved by means of an ion path connecting both sides through effective contact between the exposed part of the intermediate layer and an active material, thereby improving the electrical performance.

In addition, the composite electrode prepared from the composite current collector helps to improve the compaction density of the electrode and the thickness of a coating film.

Meanwhile, since an ion conducting path is added to the original farthest end of the ion conductor of an active material layer of the electrode, the composite electrode made by using the composite current collector helps to ensure the capacity performance of cathode and anode active materials under high electrode compaction density and high coating weights of the cathode and anode active materials, thereby further improving the energy density of the electrode assembly.

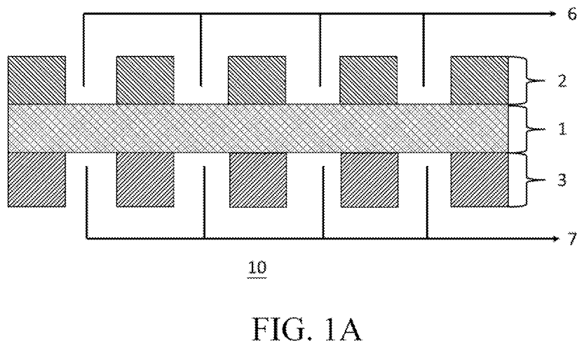

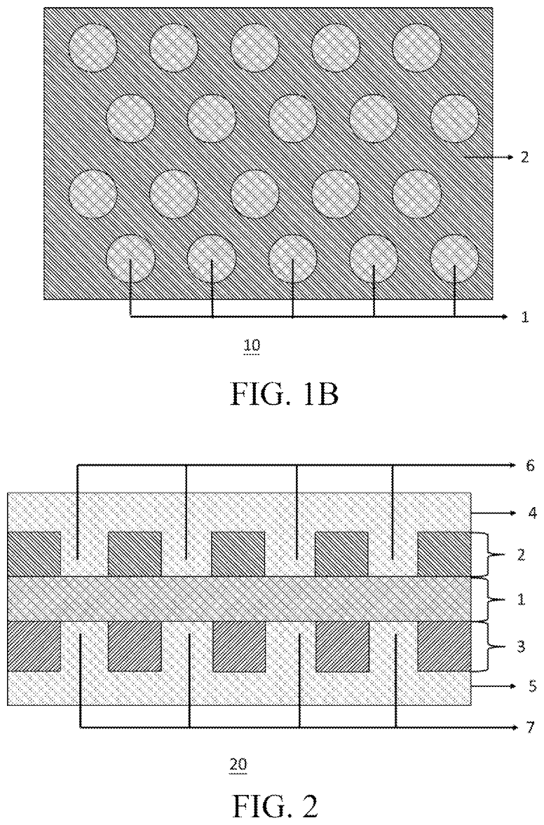

The structure and material composition of a composite current collector in various embodiments of the present application, and the configuration of the composite current collector in a composite electrode and an electrochemical device will be further described below in conjunction with FIG. 1 and FIG. 2.

### 1. Composite Current Collector

FIG. 1A and FIG. 1B are cross-sectional and top-view structure diagrams of a composite current collector according to some embodiments of the present application respectively.

As shown in FIG. 1A and FIG. 1B, a composite current collector 10 of the present application includes: an intermediate layer 1, two side surfaces, namely a first surface and a second surface, with the intermediate layer 1 being provided with a first metal layer 2 and a second metal layer 3 respectively. The intermediate layer 1 is an electrically insulated ionic conductor. The first metal layer 2 and the second metal layer 3 are provided with holes 6 and 7 respectively, so that a part of the first surface and a part of the second surface of the intermediate layer 1 are exposed. A composite current collector layer allows a part of cathode and anode active materials to be filled in the holes 6 and 7. In addition, since the intermediate layer 1 is an electrically insulated ionic conductor, the holes 6 and 7 can further form an ion path connecting both sides of the composite current collector, so that the ion conductivity is improved, thereby effectively improving the energy density of the electrode assembly, which is advantageous to improve the compaction density of the electrode and the thickness of a coating film.

As shown in FIG. 1B, the holes 6 and 7 are circular hole-shaped holes that present even distribution in the first metal layer 2 and the second metal layer 3. It should be understood that the shape and distribution of the holes 6 and 7 are not particularly limited, as long as a part of the first surface and the second surface of the intermediate layer 1 can be exposed. In some embodiments, the holes 6 and 7 may be, for example, but are not limited to be, circular, elliptical, triangular, square, rectangular, etc. In some embodiments, the holes 6 and 7 may present even distribution or may present uneven distribution.

In some embodiments, the average pore size of the holes 6 and 7 ranges from about 20 μm to about 3,000 μm. When the pore size is too small, the ion conductivity of a single hole is limited, and it is difficult to improve an ion conducting path. When the pore size is too large, the surface area ratio of a single hole is too large, which affects electron transmission path near the hole, reduces the electron conductivity of the first metal layer 2 or the second metal layer 3, and is disadvantageous to the electrical performance of an electrode assembly.

In some embodiments, the average pore density of the holes 6 and 7 ranges from about 1 pore/cm² to about 100 pores/cm². When the pore density is too small, the region of a single hole capable of improving the ion conductivity is limited, and some active material regions far away from the hole cannot achieve the purpose of improving an ion conducting path. When the pore density is too large, electron transmission path near each hole may be affected, thereby reducing the electron conductivity of a metal plating layer, which is disadvantageous to the electrical performance of an electrode assembly.

In some embodiments, the average pore area ratio of the holes 6 and 7 ranges from about 0.001% to about 30%. When the pore area ratio is too small, the improvement of the total ion conductivity of each hole is limited, which fails to effectively achieve the purpose of improving the ion conducting path. When the pore area ratio is too large, an entire electron transmission path may be affected, thereby reducing the electron conductivity of a metal plating layer, which is disadvantageous to the electrical performance of an electrode assembly.

In some embodiments, the intermediate layer 1 is a polymer material, which is at least one selected from the group consisting of polyvinylidene fluoride-hexafluoropropylene, polyvinylidene fluoride, polyacrylonitrile, polymethyl methacrylate, polyphenyl ether, polypropylene carbonate, polyethylene oxide, and derivatives thereof.

In some embodiments, the porosity of the intermediate layer 1 ranges from about 0% to about 50%. The intermediate layer has certain porosity, which facilitates weight reduction and increases the active material loading thereof while increasing the surface area of the composite current collector to improve the electron transmission path. As the porosity is larger, a larger area of the surface of the intermediate layer 1 may be covered by a metal layer when the first metal layer 2 or the second metal layer 3 is prepared. For example, an inner wall of a hole near the surface of the intermediate layer 1 is also evaporated and plated with a layer of metal to become a part of the first metal layer 2 or the second metal layer 3 in a practical sense. However, if the porosity is too large, when forming the first metal layer 2 and the second metal layer 3 on the surface of the intermediate layer, the metal layers on both sides of the intermediate layer 2 may be penetrated through the intermediate layer and connected together, resulting in failures caused by the direct connection of cathode and anode current collectors of the entire electrode assembly.

In some embodiments, the thickness of the intermediate layer is about 1 μm to about 20 μm. The thickness of the intermediate layer 1 cannot be too large, so as to ensure the energy density of the electrode assembly; the thickness of the intermediate layer 1 cannot be too small, so as to ensure that the intermediate layer 1 has certain thickness and high mechanical strength, thereby avoiding failures caused by mutual connection of the first metal layer 2 and the second metal layer 3 on both sides of the intermediate layer 1.

In some embodiments, the first metal layer 2 and the second metal layer 3 may be the same metal and a combination thereof (alloy), or may be two different metals and a combination (alloy) thereof. In some embodiments, the first metal layer 2 and the second metal layer 3 may be at least one independently selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and a combination (alloy) thereof.

According to some embodiments of the present application, the porosity of the first metal layer 2 and the second metal layer 3 is about 0% to about 60%. The first metal layer 2 and the second metal layer 3 have certain porosity, which facilitates weight reduction and increases the active material loading thereof However, when the porosity is too large, pores in a metal plating layer are excessive, so that a transmission path of internal electrons along the metal plating layer is lengthened, and the electron conductivity is decreased, thereby affecting the electrical performance of the electrode assembly.

According to some embodiments of the present application, the thickness of the first metal layer 2 and the second metal layer 3 is about 0.1 μm to about 10 μm. In some embodiments, the thickness of the first metal layer 2 and the second metal layer 3 is equal to or smaller than the thickness of the existing current collector, which is advantageous for ensuring the energy density of the electrode assembly. In addition, when the first metal layer 2 and the second metal layer 3 are too thick, the production efficiency of a preparation process is affected, and the preparation speed of the entire electrode assembly is reduced. The thickness of the first metal layer 2 and the second metal layer 3 should not be too small, so as to ensure that the first metal layer 2 and the second metal layer 3 have high electron conductivity, thereby ensuring the electrical performance of the electrode assembly.

In some embodiments, a preparation method of the composite current collector includes the following steps: forming the first metal layer 2 and the second metal layer 3 on both sides of the surface of the intermediate layer 1 respectively by, for example, but not limited to, sputtering, vacuum deposition, ion plating, laser pulse deposition, etc., wherein the first metal layer 2 and the second metal layer 3 may be patterned by, for example, but is not limited to, photomask deposition, etc. to form the holes 6 and 7, thereby completing the preparation of the composite current collector 10. It should be understood that a person skilled in the art can select a conventional preparation method in the art to replace any specific preparation method in the above process according to actual operation requirements without being limited thereto.

### 2. Composite Electrode

Some embodiments of the present application provide a composite electrode including the composite current collector of the present application. The composite electrode of the present application is beneficial to the infiltration of an electrolytic solution, and cannot only improve the speed of a liquid injection process during the processing of a battery, but also accelerate the ion passing rate after the use of the battery, thereby further improving the battery rate performance.

FIG. 2 is a structure diagram of a composite electrode 20 according to some embodiments of the present application.

As shown in FIG. 2, the composite electrode 20 provided by the present application includes: the composite current collector 10 in the above embodiments, a cathode active material layer 4 and an anode active material layer 5. The cathode active material layer 4 is disposed on the first metal layer 2, and the anode active material layer 5 is disposed on the second metal layer 3. Since the intermediate layer 1 has ion conductivity, cathode and anode active materials on both sides of the composite current collector 10 can be connected by the holes 6 and 7 on both sides to form an ion path, thereby effectively improving the electrical performance of the composite electrode 20. The cathode active material layer 4 and the anode active material layer 5 may be prepared by using materials, structures and manufacturing methods well known in the art.

In some embodiments, the cathode active material layer 4 includes at least one lithiated intercalation compound reversibly intercalating and deintercalating lithium ions, including but not limited to one or more of lithium cobaltate, lithium nickel cobalt manganese oxide, lithium nickel cobalt aluminate, lithium manganate, lithium manganese iron phosphate, lithium vanadium phosphate, lithium vanadium oxide phosphate, lithium iron phosphate, lithium titanate, and lithium-rich manganese-based materials.

In some embodiments, the anode active material layer includes any substance capable of electrochemically absorbing and releasing metal ions such as lithium ions. In some embodiments, the anode active material layer includes a carbonaceous material, a silicon carbon material, an alloy material, or a lithium-containing metal composite oxide material. In some embodiments, the anode active material layer includes one or more of those as described above.

In some embodiments, when the anode active material layer includes an alloy material, the anode active material layer may be formed by using methods such as evaporation, sputtering, or plating.

In some embodiments, when the anode active material layer includes lithium metal, for example, the anode active material layer is formed by a conductive skeleton having a spherical twist shape and metal particles dispersed in the conductive skeleton, the spherical twist conductive skeleton may have the porosity of about 5% to about 85%, and a protective layer may be provided on the lithium metal anode active material layer.

In some embodiments, the above composite electrode 20 may be prepared by respectively coating both sides of the composite current collector 10 with cathode and anode active materials, wherein the presence of the holes 6 and 7 helps to ensure the capacity performance of the cathode and anode active materials under high electrode compaction density and high coating weights of the cathode and anode active materials, thereby further improving the energy density of the composite electrode.

In some embodiments, the coating weight of the cathode active material layer 4 on the composite current collector 10 is about 100 g/m² to about 500 g/m², and the coating weight of the anode active material layer 5 on the composite current collector 10 is about 50 g/m² to about 300 g/m². In some other embodiments, the coating weight of the cathode active material layer 4 on the composite current collector 10 is about 180 g/m² to about 200 g/m², and the coating weight of the anode active material layer 5 on the composite current collector 10 is about 95 g/m² to about 105 g/m².

In some embodiments, the compaction density of the cathode active material layer 4 is about 2.0 g/cm³ to about 5 g/cm³, and the compaction density of the anode active material layer 5 is about 1.0 g/cm³ to about 2.5 g/cm³. In some other embodiments, the compaction density of the cathode active material layer 4 is about 4.0 g/cm³ to about 4.20 g/cm³, and the compaction density of the anode active material layer 5 is about 1.7 g/cm³ to about 1.85 g/cm³.

It should be understood that in the embodiments shown in FIG. 2, the cathode active material layer 4 and the anode active material layer 5 completely cover the holes 6 and 7, respectively, and the holes 6 and 7 are completely filled, but FIG. 2 is only used as an exemplary embodiment of the composite electrode 20 of the present application. In some embodiments, the cathode active material layer 4 and the anode active material layer 5 may not cover or cover only a part of the exposed part of the intermediate layer 1 (such as the holes 6 and 7). In some other embodiments, the cathode active material layer 4 and the anode active material layer 5 may not be completely filled or only partially filled in the holes 6 and 7.

In some embodiments, the composite electrode may further include a conductive coating layer (not shown in drawings), wherein the conductive coating layer is disposed in at least one of the following two situations: between the cathode active material layer 4 and the first metal layer 2, or between the anode active material layer 5 and the second metal layer 3. The addition of the conductive coating layer may further increase the electron conducting path and improve the electrical performance; and meanwhile, the adhesion between the active material and the composite current collector is improved.

In some embodiments, the conductive coating layer includes a conductive agent and a polymer, wherein the conductive agent is at least one selected from the group consisting of carbon nanotubes, conductive carbon black, acetylene black, artificial graphite, graphene, and metal nanowires; and the polymer is at least one selected from the group consisting of polyethylene terephthalate, polybutylene terephthalate, polyethylene naphthalate, polyetheretherketone, polyimide, polyamide, polyethylene glycol, polyamideimide, polycarbonate, cyclic polyolefin, polyphenylene sulfide, polyvinyl acetate, polytetrafluoroethylene, polymethylene naphthalene, polyvinylidene difluoride, polyethylene naphthalate, polypropylene carbonate, poly(vinylidene fluoride-hexafluoropropylene), poly(vinylidene fluoride-co-chlorotrifluoroethylene), silicone, vinylon, polypropylene, polyethylene, polyvinyl chloride, polystyrene, polyether nitrile, polyurethane, polyphenylene ether, polyester, polysulfone, and derivatives thereof. The presence of the conductive coating layer may further increase the electron conducting path and improve the electrical performance; and meanwhile, the adhesion between the cathode and anode active material layers and the composite current collector is improved.

### 3. Electrochemical Device

Some embodiments of the present application further provide an electrochemical device including the composite current collector of the present application. In some embodiments, the electrochemical device is a lithium-ion battery. The lithium-ion battery includes an electrode assembly composed of a composite electrode of the present application, a tab and a separator, and an electrolytic solution.

In some embodiments of the present application, a preparation method of the lithium-ion battery includes: laminating and winding the composite electrode of the present application and the separator together to form the electrode assembly. The electrode assembly is then charged into, for example, an aluminum plastic film, and the electrolytic solution is injected. Then, vacuum encapsulation, standing, formation, shaping and other processes are performed to obtain a lithium-ion battery.

The electrolytic solution and the separator used in the present application are not particularly limited, and may be prepared by using materials, structures and manufacturing methods well known in the art.

For example, the separator may include a substrate layer and a surface treatment layer. The substrate layer is a nonwoven fabric, a film or a composite film having a porous structure, and the material of the substrate layer is at least one selected from polyethylene, polypropylene, polyethylene terephthalate and polyimide. Specifically, a polypropylene porous film, a polyethylene porous film, polypropylene nonwoven cloth, polyethylene nonwoven cloth or a polypropylene-polyethylene-polypropylene porous composite film can be adopted.

At least one surface of the substrate layer is provided with the surface treatment layer, and the surface treatment layer may be a polymer layer or an inorganic substance layer, or may be a layer formed by mixing a polymer and an inorganic substance.

The inorganic substance layer includes inorganic particles and a binder, and the inorganic particles are selected from one or a combination of several of aluminum oxide, silicon oxide, magnesium oxide, titanium oxide, hafnium oxide, tin oxide, cerium oxide, nickel oxide, zinc oxide, calcium oxide, zirconium oxide, yttrium oxide, silicon carbide, boehmite, aluminum hydroxide, magnesium hydroxide, calcium hydroxide and barium sulfate. The binder is selected from one or a combination of several of polyvinylidene fluoride, vinylidene fluoride-hexafluoropropylene copolymer, polyamide, polyacrylonitrile, polyacrylate, polyacrylic acid, polyacrylate, polyvinylpyrrolidone, polyvinyl ether, polymethyl methacrylate, polytetrafluoroethylene and polyhexafluoropropylene. The polymer layer includes a polymer, and the material of the polymer is at least one selected from polyamide, polyacrylonitrile, acrylate polymer, polyacrylic acid, polyacrylate, polyvinylpyrrolidone, polyvinyl ether, polyvinylidene fluoride and poly(vinylidene fluoride-hexafluoropropylene).

The separator needs to have mechanically robustness to withstand the stretching and piercing of the electrode material, and a pore size of the separator is typically less than 1 micron. Various separators including microporous polymer membranes, non-woven mats and inorganic membranes have been used in the lithium-ion batteries, wherein the polymer membranes based on microporous polyolefin materials are the most commonly used separators in combination with the electrolytic solution. The microporous polymer membranes can be made very thin (typically about 5 μm-25 μm) and highly porous (typically about 20%-50%) to reduce electrical resistance and improve ion conductivity. Meanwhile, the polymer membrane still has mechanical robustness. A person skilled in the art will appreciate that various separators widely used in the lithium-ion batteries are suitable for use in the present application. In some embodiments, the electrolytic solution includes a lithium salt and a non-aqueous solvent. The lithium salt is one or more selected from the group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB and lithium difluoroborate. For example, LiPF6 is selected as the lithium salt because it can give high ionic conductivity and improve cycle characteristics. The non-aqueous solvent can be a carbonate compound, a carboxylate compound, an ether compound, other organic solvent or a combination thereof.

The carbonate compound may be a chain carbonate compound, a cyclic carbonate compound, a fluorocarbonate compound, or a combination thereof.

Examples of other organic solvents are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate and a combination thereof.

It should be appreciated by a person skilled in the art that although the lithium-ion battery is used as an example for description above, the person skilled in the art, after reading this application, can think of that the composite current collector of this application can be used in other suitable electrochemical devices. Such electrochemical devices include any device for electrochemical reaction, and specific examples thereof include all kinds of primary batteries, secondary batteries, fuel cells, solar cells or capacitors. In particular, the electrochemical device is a lithium secondary battery, including a lithium metal secondary battery, a lithium-ion secondary battery, a lithium polymer secondary battery or a lithium ion polymer secondary battery.

The composite current collector of the present application and the electrochemical device including the same have the following beneficial effects: (1) the preparation process of the electrode assembly is simplified, production efficiency and product optimization rate are improved, and production cost is reduced; (2) the volume energy density and mass energy density of the electrochemical device are further improved; (3) metal burrs caused by cutting are eliminated, the self-discharge problem caused by micro-short circuit inside the electrode assembly is improved, and the safety performance of the electrochemical device is improved; (4) a hole is provided in the composite current collector, so that ion path connecting cathode and anode materials on both sides of the composite current collector is increased; (5) the composite current collector containing the hole helps to improve the compaction density of the electrode and the thickness of a coating film, thereby improving the energy density of the electrode assembly; and (6) the composite current collector structure containing the hole is beneficial to the sufficient infiltration of the electrolytic solution as, on the one hand, the speed of the liquid injection process can be increased, and on the other hand, the ion passing rate can be accelerated, and the rate performance of the electrochemical device can be further improved.

### 4. Electronic Device

Some embodiments of the present application further provide an electronic device, including the electrochemical device in the embodiments of the present application.

The electronic device of the present application is not particularly limited and can be any electronic device known in the art. In some embodiments, the electronic device can include, but are not limited to, notebook computers, pen input computers, mobile computers, e-book players, portable telephones, portable fax machines, portable copy machines, portable printers, headset stereo headphones, VCRs, LCD TVs, portable cleaners, portable CD players, mini disc players, transceivers, electronic notebooks, calculators, memory cards, portable recorders, radios, backup powers, motors, cars, motorcycles, power bicycles, bicycles, lighting fixtures, toys, game consoles, clocks, power tools, flashlights, cameras, large household batteries, lithium ion capacitors, etc.

Hereinafter, the lithium-ion battery is taken as an example and the preparation of the lithium-ion battery is described in conjunction with a specific embodiment. A person skilled in the art will understand that the preparation method described in the present application is merely an example, and any other suitable preparation methods fall within the scope of the present application.

### 5. Specific Embodiment

After the lithium-ion battery of the following specific embodiments and comparative examples is completed, the weight and volume size of the lithium-ion battery are recorded. The lithium-ion battery is then subjected to discharge energy density detection at different discharge rates of 0.1 C and 2 C. A specific embodiment of the discharge energy density detection will be described below.

Discharge Energy Density Detection
(1) Energy Density (Wh/L) During Discharge at 0.1 C

A lithium-ion battery was allowed to stand at a normal temperature for 30 minutes, and was charged at a constant current of 0.05 C to a voltage of 4.4 V (nominal voltage), and then an electrochemical device was discharged to 3.0 V at a rate of 0.05 C. The above charge/discharge steps were repeated for 3 cycles to complete the formation of the electrochemical device to be tested. After completing the formation of the electrochemical device, the device was charged at a constant current of 0.1 C to a voltage of 4.4 V, then the electrochemical device was discharged to 3.0 V at a discharge rate of 0.1 C, the discharge capacity was recorded, and then the energy density thereof during discharge at 0.1 C was calculated:

Energy density (Wh/L)=discharge capacity (Wh)/lithium-ion battery volume size (L)

(2) Energy Density (Wh/L) During Discharge at 2 C

A lithium-ion battery was allowed to stand at a normal temperature for 30 minutes, and was charged at a constant current of 0.05 C to a voltage of 4.4 V (nominal voltage), and then an electrochemical device was discharged to 3.0 V at a rate of 0.05 C. The above charge/discharge steps were repeated for 3 cycles to complete the formation of the electrochemical device to be tested. After completing the formation of the electrochemical device, the device was charged at a constant current of 2 C to a voltage of 4.4 V, then the electrochemical device was discharged to 3.0 V at a discharge rate of 2 C, the discharge capacity was recorded, and then the energy density thereof during discharge at 0.1 C was calculated:

Energy density (Wh/L)=discharge capacity (Wh)/lithium-ion battery volume size (L)

### Embodiment 1

(1) Preparation of Composite Current Collector

On the surface of a polyvinylidene fluoride (PVDF) film (that is, an intermediate layer) having the thickness of 12 μm, a layer of metal Cu having the thickness of about 0.5 μm and a metal Al plating layer were separately prepared on both sides of the polyvinylidene fluoride (PVDF) film by vacuum deposition as current collectors for a cathode active material and an anode active material (that is, a first metal layer and a second metal layer). In the process of preparing the first metal layer and the second metal layer, a part of the surface of a film substrate was covered with a mask to make the region free of the first metal layer and the second metal layer, thereby forming holes in the first metal layer and the second metal layer. The preparation of a double-sided heterogeneous composite current collector was completed. The holes prepared in the first metal layer and the second metal layer were circular holes, the pore size was 20 μm, and the pore density was 4 pores/cm². The holes were evenly distributed over the entire surface of the composite current collector, and a ratio of the total area of all the holes to the entire surface of the composite current collector was 0.001% in this case.

(2) Preparation of Electrode

Cathode active materials lithium cobaltate (LiCoO₂), conductive carbon black (Super P) and polyvinylidene fluoride were mixed at a weight ratio of about 97.5:1.0:1.5, N-methylpyrrolidone (NMP) was added as a solvent, and slurry having a solid content of about 0.75 was prepared and stirred evenly. The slurry was evenly coated on a metal Al plating layer of the composite current collector, and the weight of the cathode active materials on an electrode was about 180 g/m². Drying was performed at 90° C. to complete single-sided coating on a cathode side of the electrode. After the coating was completed, the cathode active material layer of the electrode was cold-pressed to a compaction density of about 4.0 g/cm³ to complete the entire preparation process of the cathode side of the electrode.

Subsequently, anode active materials graphite, conductive carbon black (Super P) and styrene-butadiene rubber (SBR) were mixed at a weight ratio of about 96:1.5:2.5, deionized water (H₂O) was added as a solvent, and slurry having a solid content of about 0.7 was prepared and stirred evenly. The slurry was evenly coated on a metal Cu plating layer of the composite current collector, and the weight of the anode active materials on an electrode was about 95 g/m₂. Drying was performed at 110° C. to complete single-sided coating on an anode side of the electrode. After the coating was completed, the anode active material layer of the electrode was cold-pressed to a compaction density of about 1.7 g/cm³. Subsequently, auxiliary processes such as tab welding and gummed paper pasting were used to complete the entire preparation process of all electrodes based on the double-sided heterogeneous composite current collector.

(3) Preparation of Electrolytic Solution

In a dry argon atmosphere, organic solvents ethylene carbonate (EC), ethyl methyl carbonate (EMC) and diethyl carbonate (DEC) were first mixed in an EC:EMC:DEC mass ratio of about 30:50:20, and then a lithium salt lithium hexafluorophosphate (LiPF₆) was added to the organic solvents to be dissolved and evenly mixed to obtain an electrolytic solution having the lithium salt concentration of about 1.15 M.

(4) Preparation of Lithium-Ion Battery

Polyethylene (PE) with the thickness of about 15 μm was used as a separator, the separator and the electrode based on the double-sided heterogeneous composite current collector were stacked in order, then the stacked electrode and separator were rolled into an electrode assembly. The electrode assembly was injected with liquid after top side sealing, the liquid-injected electrode assembly was formed (charged to about 3.3 V at a constant current of 0.02 C and then charged to about 3.6 V at a constant current of 0.1 C), and then the performance of the electrode assembly was preliminarily detected. A soft-packed lithium-ion battery was finally obtained.

### Embodiment 2

The preparation manner of the present embodiment was the same as that of Embodiment 1, except that in (1) of Embodiment 2, the pore size was about 100 μm, and the pore area ratio was about 0.03%.

### Embodiment 3

The preparation manner of the present embodiment was the same as that of Embodiment 1, except that in (1) of Embodiment 3, the pore size was about 500 μm, and the pore area ratio was about 0.80%.

### Embodiment 4

The preparation manner of the present embodiment was the same as that of Embodiment 1, except that in (1) of Embodiment 4, the pore size was about 3,000 μm, and the pore area ratio was about 28%.

### Embodiment 5

The preparation manner of the present embodiment was the same as that of Embodiment 3, except that in (1) of Embodiment 5, the pore density was about 1 pore/cm², and the pore area ratio was about 0.20%.

### Embodiment 6

The preparation manner of the present embodiment was the same as that of Embodiment 3, except that in (1) of Embodiment 6, the pore density was about 10 pores/cm², and the pore area ratio was about 2.0%.

### Embodiment 7

The preparation manner of the present embodiment was the same as that of Embodiment 3, except that in (1) of Embodiment 7, the pore density was about 25 pores/cm², and the pore area ratio was about 5%.

### Embodiment 8

The preparation manner of the present embodiment was the same as that of Embodiment 3, except that in (1) of Embodiment 8, the pore density was about 100 pores/cm², and the pore area ratio was about 20%.

### Embodiment 9

The preparation manner of the present embodiment was the same as that of Embodiment 1, except that in (1) of Embodiment 9, the pore size was about 1,100 μm, the pore density was 1/cm², and the pore area ratio was about 1.0%.

### Embodiment 10

The preparation manner of the present embodiment was the same as that of Embodiment 9, except that in (1) of Embodiment 10, the pore density was about 10 pores/cm², and the pore area ratio was about 10%.

### Embodiment 11

The preparation manner of the present embodiment was the same as that of Embodiment 9, except that in (1) of Embodiment 11, the pore density was about 32 pores/cm², and the pore area ratio was about 30%.

### Embodiment 12

The preparation manner of the present embodiment was the same as that of Embodiment 1, except that in (1) of Embodiment 12, on the surface of a polyacrylonitrile (PAN) film (that is, an intermediate layer) having the thickness of about 12 μm, a layer of metal Cu having the thickness of about 0.5 μm and a metal Al plating layer were separately prepared on both sides by vacuum deposition as current collectors for a cathode active material and an anode active material (that is, a first metal layer and a second metal layer). In the process of preparing the first metal layer and the second metal layer, a part of the surface of a film substrate was covered with a mask to make the region free of the first metal layer and the second metal layer, thereby forming holes in the first metal layer and the second metal layer. Subsequently, drying was performed at 90° C. to complete the preparation of a double-sided heterogeneous composite current collector. The holes prepared in the first metal layer and the second metal layer were circular holes, the pore size was about 500 μm, and the pore density was about 25 pores/cm². The holes were evenly distributed over the entire surface of the composite current collector, and the total area of all the holes on the entire surface of the composite current collector was about 5.0% in this case.

### Embodiment 13

The preparation manner of the present embodiment was the same as that of Embodiment 1, except that in (1) of Embodiment 13, on the surface of a polyethylene oxide (PEO) film (that is, an intermediate layer) having the thickness of 12 μm, a layer of metal Cu having the thickness of 0.5 μm and a metal Al plating layer were separately prepared on both sides of the polyethylene oxide (PEO) film by vacuum deposition as current collectors for a cathode active material and an anode active material (that is, a first metal layer and a second metal layer). In the process of preparing the first metal layer and the second metal layer, a part of the surface of a film substrate was covered with a mask to make the region free of the first metal layer and the second metal layer, thereby forming holes in the first metal layer and the second metal layer. Subsequently, drying was performed at 90° C. to complete the preparation of a double-sided heterogeneous composite current collector. The holes prepared in the first metal layer and the second metal layer were circular holes, the pore size was about 500 μm, and the pore density was about 25 pores/cm². The holes were evenly distributed over the entire surface of the composite current collector, and the total area of all the holes on the entire surface of the composite current collector was about 5.0% in this case.

### Embodiment 14

The preparation manner of the present embodiment was the same as that of Embodiment 1, except that in (1) of Embodiment 14, on the surface of a polypropylene carbonate (PPC) film (that is, an intermediate layer) having the thickness of about 12 μm, a layer of metal Cu having the thickness of about 0.5 μm and a metal Al plating layer were separately prepared on both sides of the polypropylene carbonate (PPC) film by vacuum deposition as current collectors for a cathode active material and an anode active material (that is, a first metal layer and a second metal layer). In the process of preparing the first metal layer and the second metal layer, a part of the surface of a film substrate was covered with a mask to make the region free of the first metal layer and the second metal layer, thereby forming holes in the first metal layer and the second metal layer. Subsequently, drying was performed at 90° C. to complete the preparation of a double-sided heterogeneous composite current collector. The holes prepared in the first metal layer and the second metal layer were circular holes, the pore size was about 500 μm, and the pore density was about 25 pores/cm². The holes were evenly distributed over the entire surface of the composite current collector, and the total area of all the holes on the entire surface of the composite current collector was about 5.0% in this case.

### Embodiment 15

The preparation manner of the present embodiment was the same as that of Embodiment 7, except that in (2) of Embodiment 15, the weight of the cathode active material on the electrode was about 190 g/m², and the weight of the anode active material on the electrode was about 100 g/m².

### Embodiment 16

The preparation manner of the present embodiment was the same as that of Embodiment 7, except that in (2) of Embodiment 16, the weight of the cathode active material on the electrode was about 200 g/m², and the weight of the anode active material on the electrode was about 105 g/m².

### Embodiment 17

The preparation manner of the present embodiment was the same as that of Embodiment 7, except that in (2) of Embodiment 17, the cathode active material on the electrode was cold-pressed to a compaction density of about 4.10 g/cm³, and the anode active material layer was cold-pressed to a compaction density of about 1.77 g/cm³.

### Embodiment 18

The preparation manner of the present embodiment was the same as that of Embodiment 7, except that in (2) of Embodiment 18, the cathode active material on the electrode was cold-pressed to a compaction density of about 4.20 g/cm³, and the anode active material layer was cold-pressed to a compaction density of about 1.85 g/cm³.

### Embodiment 19

The preparation manner of the present embodiment was the same as that of Embodiment 7, except that before the preparation of the electrode in (2) of Embodiment 19, first coating (with a conductive coating layer) was performed on the current collector prepared in the previous step: conductive carbon black (Super P) and styrene-butadiene rubber (SBR) were mixed at a weight ratio of about 95:5, deionized water (H₂O) was added as a solvent, and slurry having a solid content of about 0.8 was prepared and stirred evenly. The slurry was evenly coated on a metal Cu plating layer of the composite current collector and dried at 110° C. to obtain an anode first-coat layer, conductive carbon black (Super P) and styrene-butadiene rubber (SBR) were mixed at a weight ratio of about 97:3, deionized water (H₂O) was added as a solvent, and slurry having a solid content of about 0.85 was prepared and stirred evenly. The slurry was evenly coated on a metal Al plating layer of the composite current collector and dried at 110° C. to obtain a cathode first-coat layer.

### Comparative Example 1

(1) Preparation of Anode

Anode active materials graphite, conductive carbon black (Super P) and styrene-butadiene rubber (SBR) were mixed at a weight ratio of 96:1.5:2.5, deionized water (H₂O) was added as a solvent, and slurry having a solid content of 0.7 was prepared and stirred evenly. The slurry was evenly coated on one side of anode current collector copper foil, wherein the weight of the anode active material was 95 g/m². Drying was performed at 110° C. to obtain an anode. Subsequently, the above steps were also carried out on the other side of the anode current collector copper foil in the same manner to obtain a double-sided coated anode. Subsequently, the anode was cold-pressed to a compaction density of 1.7 g/cm³.

(2) Preparation of Cathode

Cathode active materials lithium cobaltate, conductive carbon black and polyvinylidene difluoride were mixed at a weight ratio of 97.5:1.0:1.5, N-methylpyrrolidone was added as a solvent, and slurry having a solid content of 0.75 was prepared and stirred evenly. The slurry was evenly coated on one side of cathode current collector aluminum foil, wherein the weight of the cathode active material was 180 g/m². The slurry was dried at 90° C. to obtain a cathode. Subsequently, the above steps were also carried out on the other side of the cathode current collector aluminum foil in the same manner to obtain a double-sided coated cathode. Subsequently, the cathode was cold-pressed to a compaction density of 4.0 g/cm³.

(3) Preparation of Electrolytic Solution

In a dry argon atmosphere, organic solvents ethylene carbonate (EC), ethyl methyl carbonate (EMC) and diethyl carbonate (DEC) were first mixed in a mass ratio of EC:EMC:DEC=30:50:20, and then a lithium salt lithium hexafluorophosphate (LiPF₆) was added to the organic solvents to be dissolved and evenly mixed to obtain an electrolytic solution having the lithium salt concentration of 1.15 M.

(4) Preparation of Lithium-Ion Battery

Polyethylene (PE) with the thickness of 15 μm was used as a separator, the cathode, the separator and the anode were stacked in order to make the separator in the center position, then the stacked electrode and separator were rolled into an electrode assembly, the electrode assembly was injected with liquid after top side sealing, the liquid-injected electrode assembly was formed (charged to 3.3 V at a constant current of 0.02 C and then charged to 3.6 V at a constant current of 0.1 C), and then the performance of the electrode assembly was preliminarily detected. A soft-packed lithium-ion battery was finally obtained.

### Comparative Example 2

The preparation manner of the present comparative example was the same as that of Embodiment 1, except that in (1) of Comparative Example 2, the double-sided heterogeneous composite current collector was prepared on the surface of a polyvinylidene fluoride film having the thickness of 12 μm, a layer of metal Cu having the thickness of 0.5 μm and a metal Al plating layer were separately prepared on both sides of the polyvinylidene fluoride film by vacuum deposition as current collectors for anode and cathode active materials without forming a hole.

### Comparative Example 3

The preparation manner of the present comparative example was the same as that of Comparative Example 2, except that in (2) of Comparative Example 3, the weight of the cathode active material on the electrode was about 200 g/m², and the weight of the anode active material on the electrode was about 105 g/m².

### Comparative Example 4

The preparation manner of the present comparative example was the same as that of Comparative Example 2, except that in (2) of Comparative Example 4, the cathode active material layer of the electrode was cold-pressed to a compaction density of about 4.20 g/cm³, and the anode active material layer was cold-pressed to a compaction density of about 1.85 g/cm³.

The specific embodiment parameters of the above Embodiments 1-19 and Comparative Examples 1-4 and the discharge energy density and discharge energy percentage results thereof are shown in Table 1 below.

TABLE 1

| | | | | | | | | | Energy | Energy | |
|---|---|---|---|---|---|---|---|---|---|---|---|
| | | | | | | | | | density | density | |
| | | | | | Cathode | Anode | Cathode | Anode | during | during | |
| | Average | Pore | | In-hole | compaction | compaction | coating | coating | discharge | discharge | 2 C/0.1 C |
| | pore size | density | Pore area | filling | density | density | weight | weight | at 0.1 C | at 2 C | discharge |
| | (μm) | (pore/cm²) | ratio (%) | material | (g/cm³) | (g/cm³) | (g/m²) | (g/m²) | (Wh/L) | (Wh/L) | energy (%) |
| Comparative | — | — | — | — | 4.00 | 1.70 | 180 | 95 | 623 | 513 | 82.30% |
| Example 1 | | | | | | | | | | | |
| Comparative | — | — | — | — | 4.00 | 1.70 | 180 | 95 | 649 | 524 | 80.80% |
| Example 2 | | | | | | | | | | | |
| Comparative | — | — | — | — | 4.00 | 1.70 | 200 | 105 | 685 | 520 | 75.90% |
| Example 3 | | | | | | | | | | | |
| Comparative | — | — | — | — | 4.20 | 1.85 | 180 | 95 | 686 | 518 | 75.50% |
| Example 4 | | | | | | | | | | | |
| Embodiment 1 | 20 | 4 | 0.001% | PVDF | 4.00 | 1.70 | 180 | 95 | 649 | 526 | 81.00% |
| Embodiment 2 | 100 | 4 | 0.03% | PVDF | 4.00 | 1.70 | 180 | 95 | 650 | 528 | 81.30% |
| Embodiment 3 | 500 | 4 | 0.80% | PVDF | 4.00 | 1.70 | 180 | 95 | 662 | 549 | 82.90% |
| Embodiment 4 | 3000 | 4 | 28% | PVDF | 4.00 | 1.70 | 180 | 95 | 659 | 545 | 82.70% |
| Embodiment 5 | 500 | 1 | 0.20% | PVDF | 4.00 | 1.70 | 180 | 95 | 655 | 536 | 81.80% |
| Embodiment 6 | 500 | 10 | 2.0% | PVDF | 4.00 | 1.70 | 180 | 95 | 665 | 555 | 83.50% |
| Embodiment 7 | 500 | 25 | 5.0% | PVDF | 4.00 | 1.70 | 180 | 95 | 679 | 572 | 84.20% |
| Embodiment 8 | 500 | 100 | 20% | PVDF | 4.00 | 1.70 | 180 | 95 | 673 | 563 | 83.60% |
| Embodiment 9 | 1100 | 1 | 1.0% | PVDF | 4.00 | 1.70 | 180 | 95 | 665 | 553 | 83.10% |
| Embodiment 10 | 1100 | 10 | 10% | PVDF | 4.00 | 1.70 | 180 | 95 | 676 | 568 | 84.00% |
| Embodiment 11 | 1100 | 32 | 30% | PVDF | 4.00 | 1.70 | 180 | 95 | 658 | 545 | 82.80% |
| Embodiment 12 | 500 | 25 | 5.0% | PAN | 4.00 | 1.70 | 180 | 95 | 677 | 569 | 84.10% |
| Embodiment 13 | 500 | 25 | 5.0% | PEO | 4.00 | 1.70 | 180 | 95 | 675 | 568 | 84.20% |
| Embodiment 14 | 500 | 25 | 5.0% | PPC | 4.00 | 1.70 | 180 | 95 | 680 | 574 | 84.40% |
| Embodiment 15 | 500 | 25 | 5.0% | PVDF | 4.00 | 1.70 | 190 | 100 | 691 | 573 | 82.90% |
| Embodiment 16 | 500 | 25 | 5.0% | PVDF | 4.00 | 1.70 | 200 | 105 | 706 | 575 | 81.40% |
| Embodiment 17 | 500 | 25 | 5.0% | PVDF | 4.10 | 1.77 | 180 | 95 | 688 | 570 | 82.80% |
| Embodiment 18 | 500 | 25 | 5.0% | PVDF | 4.20 | 1.85 | 180 | 95 | 704 | 572 | 81.20% |
| Embodiment 19 | 500 | 25 | 5.0% | PVDF | 4.00 | 1.70 | 180 | 95 | 682 | 578 | 84.70% |

It can be seen from Table 1 that, compared with Comparative Example 1, the lithium-ion battery in the embodiments of the present application has the inherent advantages of the double-sided heterogeneous composite current collector compared with the lithium-ion battery of common copper-aluminum foil current collectors, i.e., the electrode assembly structure can be designed to be self-winding, thereby further simplifying the electrode assembly preparation process, improving production efficiency and product optimization rate, and reducing production cost; Meanwhile, by reducing the proportion of current collector and separator materials, the volume energy density and mass energy density of the lithium-ion battery can be further improved.

In addition, compared with Comparative Example 2, i.e., compared with a lithium-ion battery using a double-sided heterogeneous composite current collector, the present application effectively improves the rate performance of the electrode assembly by improving the ion conducting path in the composite current collector, so that the energy density of the lithium-ion battery is greatly improved during large rate discharging at 2 C.

On the other hand, by comparing Comparative Example 16 with Comparative Example 3, it was found that the lithium-ion battery using the composite current collector of the present application presented superior rate performance and higher energy density at the same high coating weight, especially during large rate discharging at 2 C.

Furthermore, by comparing Comparative Example 18 with Comparative Example 4, it was found that the present invention presented superior rate performance and higher energy density at the same compaction density, especially during large rate discharging at 2 C.

Finally, by comparing Comparative Example 7 with Comparative Example 19, it was found that by providing conductive coating layers between the cathode active material layer 4 and the first metal layer 2 in the composite electrode and between the anode active material layer 5 and the second metal layer 3, the rate performance and energy density of the electrochemical device during large rate discharging at 2 C can be further optimized.

Citations of “some embodiments”, “part of embodiments”, “one embodiment”, “another example”, “example”, “specific example” or “part of examples” in the whole specification mean that at least one embodiment or example in the application includes specific features, structures, materials or characteristics described in the embodiments or examples. Thus, the descriptions appear throughout the specification, such as “in some embodiments”, “in an embodiment”, “in one embodiment”, “in another example”, “in one example”, “in a specific example” or “an example”, which does not necessarily refer to the same embodiment or example in the present application. Furthermore, the specific features, structures, materials or characteristics in the descriptions can be combined in any suitable manner in one or more embodiments or examples.

Although the illustrative embodiments have been shown and described, it should be understood by a person skilled in the art that the above embodiments cannot be interpreted as limiting the present application, and the embodiments can be changed, substituted and modified without departing from the spirit, principle and scope of the present application.

What is claimed is:

1. A composite current collector, comprising:
an intermediate layer, having a first surface and a second surface opposite to the first surface, and the intermediate layer being an electronically insulated ionic conductor;
a first metal layer, disposed on the first surface; and
a second metal layer, disposed on the second surface, wherein the first metal layer and the second metal layer are each provided with at least one hole, and the at least one hole exposes a part of the first surface and a part of the second surface.

2. The composite current collector according to claim 1, wherein the average pore size of each hole is about 20 μm to about 3,000 μm, the average pore density is about 1 pore/cm² to about 100 pores/cm², and the average pore area ratio is about 0.001% to about 30%.

3. The composite current collector according to claim 1, wherein the first metal layer and the second metal layer are each at least one independently selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and a combination thereof.

4. The composite current collector according to claim 1, wherein the ionic conductor is at least one selected from the group consisting of polyvinylidene fluoride-hexafluoropropylene (PVDF-HFP), polyvinylidene fluoride (PVDF), polyacrylonitrile (PAN), polymethyl methacrylate (PMMA), polyphenyl ether (PPO), polypropylene carbonate (PPC), polyethylene oxide (PEO), and derivatives thereof.

5. A composite electrode, comprising:
a composite current collector comprising:
an intermediate layer, having a first surface and a second surface opposite to the first surface, and the intermediate layer being an electronically insulated ionic conductor;
a first metal layer, disposed on the first surface; and
a second metal layer, disposed on the second surface, wherein the first metal layer and the second metal layer are each provided with at least one hole, the at least one hole exposes a part of the first surface and a part of the second surface;
a cathode active material layer, disposed on the first metal layer; and
an anode active material layer, disposed on the second metal layer.

6. The composite electrode according to claim 5, wherein the average pore size of the hole is about 20 μm to about 3,000 μm, the average pore density is about 1 pore/cm² to about 100 pores/cm², and the average pore area ratio is about 0.001% to about 30%.

7. The composite electrode according to claim 5, wherein the first metal layer and the second metal layer are each at least one independently selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and a combination thereof.

8. The composite electrode according to claim 5, wherein the ionic conductor is at least one selected from the group consisting of polyvinylidene fluoride-hexafluoropropylene (PVDF-HFP), polyvinylidene fluoride (PVDF), polyacrylonitrile (PAN), polymethyl methacrylate (PMMA), polyphenyl ether (PPO), polypropylene carbonate (PPC), polyethylene oxide (PEO), and derivatives thereof.

9. The composite electrode according to claim 5, wherein the cathode active material layer covers a part of the exposed part or the entire exposed part of the first surface, and the anode active material layer covers a part of the exposed part or the entire exposed part of the second surface.

10. The composite electrode according to claim 5, further comprising a conductive coating layer, disposed in at least one of the following two situations: between the cathode active material layer and the first metal layer, or between the anode active material layer and the second metal layer.

11. The composite electrode according to claim 9, further comprising a conductive coating layer, disposed in at least one of the following two situations: between the cathode active material layer and the first metal layer, or between the anode active material layer and the second metal layer.

12. The composite electrode according to claim 11, wherein the conductive coating layer comprises a conductive agent and a polymer, the conductive agent being at least one selected from the group consisting of carbon nanotubes, conductive carbon black, acetylene black, artificial graphite, graphene, and metal nanowires; and
the polymer is at least one selected from the group consisting of polyethylene terephthalate, polybutylene terephthalate, polyethylene naphthalate, polyetheretherketone, polyimide, polyamide, polyethylene glycol, polyamideimide, polycarbonate, cyclic polyolefin, polyphenylene sulfide, polyvinyl acetate, polytetrafluoroethylene, polymethylene naphthalene, polyvinylidene difluoride, polyethylene naphthalate, polypropylene carbonate, poly(vinylidene fluoride-hexafluoropropylene), poly(vinylidene fluoride-co-chlorotrifluoroethylene), silicone, vinylon, polypropylene, polyethylene, polyvinyl chloride, polystyrene, polyether nitrile, polyurethane, polyphenylene ether, polyester, polysulfone, and derivatives thereof.

13. An electrode assembly, comprising a composite electrode comprising:
a composite current collector comprising:
an intermediate layer, having a first surface and a second surface opposite to the first surface, and the intermediate layer being an electronically insulated ionic conductor;
a first metal layer, disposed on the first surface; and
a second metal layer, disposed on the second surface, wherein the first metal layer and the second metal layer are each provided with at least one hole, the at least one hole exposes a part of the first surface and a part of the second surface;
a cathode active material layer, disposed on the first metal layer; and
an anode active material layer, disposed on the second metal layer.

14. The electrode assembly according to claim 13, wherein the average pore size of the hole is about 20 μm to about 3,000 μm, the average pore density is about 1 pore/cm2 to about 100 pores/cm2, and the average pore area ratio is about 0.001% to about 30%.

15. The electrode assembly according to claim 13, wherein the first metal layer and the second metal layer are each at least one independently selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and a combination thereof.

16. The electrode assembly according to claim 13, wherein the ionic conductor is at least one selected from the group consisting of polyvinylidene fluoride-hexafluoropropylene (PVDF-HFP), polyvinylidene fluoride (PVDF), polyacrylonitrile (PAN), polymethyl methacrylate (PMMA), polyphenyl ether (PPO), polypropylene carbonate (PPC), polyethylene oxide (PEO), and derivatives thereof.

17. The electrode assembly according to claim 13, wherein the cathode active material layer covers a part of the exposed part or the entire exposed part of the first surface, and the anode active material layer covers a part of the exposed part or the entire exposed part of the second surface.

18. The electrode assembly according to claim 13, further comprising a conductive coating layer, disposed in at least one of the following two situations: between the cathode active material layer and the first metal layer, or between the anode active material layer and the second metal layer.

19. The electrode assembly according to claim 17, further comprising a conductive coating layer, disposed in at least one of the following two situations: between the cathode active material layer and the first metal layer, or between the anode active material layer and the second metal layer.

20. An electrochemical device, comprising an electrode assembly comprising:
a composite electrode comprising:
a composite current collector comprising:
an intermediate layer, having a first surface and a second surface opposite to the first surface, and the intermediate layer being an electronically insulated ionic conductor;
a first metal layer, disposed on the first surface; and
a second metal layer, disposed on the second surface, wherein the first metal layer and the second metal layer are each provided with at least one hole, the hole exposing a part of the first surface and a part of the second surface;
a cathode active material layer, disposed on the first metal layer; and
an anode active material layer, disposed on the second metal layer.
